(19) United States
(12) Patent Application Publication
(10) Pub. No.: US 2009/0247701 A1
(43) Pub. Date: Oct. 1, 2009

(54) COMPOSITION FOR FORMING AN INSULATING FILM

(75) Inventor: Haruki INABE, Haibara-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/413,017

(22) Filed: Mar. 27, 2009

(30) Foreign Application Priority Data
Mar. 28, 2008 (JP) 2008-087059

(51) Int. Cl. C08L 53/00; C08L 25/02

(52) U.S. Cl. 525/94; 525/88; 525/241

(57) ABSTRACT

An object of the invention is to provide a composition for forming an insulating film which can form an insulating film having a lowered dielectric constant using a hole forming agent, wherein the generation of spaces (voids) in which holes are connected to one another is prevented.

The above problem is solved by forming an insulating film using a composition for forming an insulating film, characterized by comprising:
(A) a polyphenylene,
(B) a styrene polymer, and
(C) a block copolymer or a graft copolymer comprising a unit having an affinity to said polyphenylene (A) and a unit having an affinity to said styrene polymer (B).

### BACKGROUND OF THE INVENTION

1. Field of the Invention

The present invention relates to a composition for forming an insulating film which can form an insulating film having excellent film properties such as dielectric constant, mechanical strength and heat-resistance, and be used for electronic devices and the like.

2. Description of the Related Art

Due to the recent progresses in high degree of integration, multi-functionalization, and performance enhancement of semiconductor integrated circuits (ICs), circuit resistance and capacitance between interconnects have increased, resulting in increases of power consumption and time delay. Because increase of time delay among other factors causes signal speed reduction and cross-talks in semiconductor integrated circuits, it is demanded to decrease circuit resistance and parasitic capacitance in order to reduce such time delay to enhance performances of semiconductor integrated circuits. As one specific means to decrease parasitic capacitance, coating of the wire periphery with a low-dielectric insulating film has been attempted. Such insulating films are required to possess excellent heat resistance which can endure the thin film-forming steps or the later steps such as steps of chip interconnection, and pin attachment, as well as chemical resistance which can endure solution processes, during the manufacture of mounted board. Moreover, Cu interconnects with low resistivity have been increasingly used in place of A1 interconnects in recent years, as a consequence, flattening by chemical mechanical polishing (CMP) has been become common process in the art. Thus, mechanical strength which can endure such processes is demanded.

Silicon dioxide (SiO₂, k=3.9) has been conventionally employed as an insulating film to coat wire periphery. However, in recent years, for the purpose of lowering the dielectric constant of insulating films, solution-processed insulating films or coating-type insulating films have been developed since insulating films of this type facilitate reduction of dielectric constant by controlling the film structure.

For example, a material for forming a solution processed low-dielectric insulating film which comprises polyphenylene based organic polymers as a main component was reported. (Japanese Laid-Open Patent Publication (Kokai) No. 2000-191752) Moreover, addition of porosity forming agents (porogen) has been attempted in recent years in order to further decrease the dielectric constant of insulating film comprised of polyphenylene based organic polymers.

Porosity forming agents are materials which form domains (discrete domains) in such a way that they degrade and/or vaporize at temperatures near cure temperatures of the matrix materials by the effect of heat or radiation (electromagnetic radiation and/or electron beam) to form holes within the matrix (therefore, these agents are also called “hole forming agents”). As the dielectric constant of the hole area formed by vaporization of the hole forming agent is around 1 (corresponding to that in vacuum), the dielectric constant of the whole insulating film can be greatly reduced. Some patent publications disclose methods to reduce the dielectric constant of insulating films comprising polyphenylene based organic polymers as main components by using hole forming agents. (Japanese Laid-open PCT Application (Kohyo) Nos. 2002-530505 and 2005-517785)

In order to attempt further lowering of the dielectric constant of the interlayer insulating film (k<2.2) by using a hole forming agent, the amount thereof to be used should be increased. However, by simply increasing the amount of the hole forming agent to be used, a problem has arisen. That is, the dimensions of individual holes formed in the matrix tend to increase and eventually connect to one another to form very large spaces (voids) within the insulating film, thereby resulting in an inadequate quality for an insulating film used for semiconductor devices.

### SUMMARY OF THE INVENTION

An object of the invention is to provide a composition for forming an insulating film which can form an insulating film using a hole forming agent, wherein the generation of spaces (voids) in which holes are connected to one another is prevented.

Another object of the invention is to provide a composition for forming an insulating film which can form an insulating film, which the composition permits to control the hole size within the insulating film, thereby providing the film with lowered dielectric constant.

The present inventors have found that addition of a certain polymer to a composition for forming an insulating film comprising polyphenylene as a main component and styrene polymer as a hole forming agent enables to control the sizes of domains formed by styrene polymer within polyphenylene matrix, thereby completed the present invention.

Therefore, the first aspect of the present invention is a composition for forming an insulating film, characterized by comprising:
(A) a polyphenylene,
(B) a styrene polymer, and
(C) a block copolymer or a graft copolymer comprising a unit or a segment having an affinity to said polyphenylene (A) and a unit or a segment having an affinity to said styrene polymer (B).

In the above composition for forming an insulating film, said unit or segment having an affinity to styrene polymer (B) is preferably a styrene polymer chain.

In the above composition for forming an insulating film, said unit having an affinity to polyphenylene (A) is preferably a polymer chain selected from the group consisting of polyethylenes, polypropylenes, polybutadienes, hydrogenated polybutadienes, polyacenaphthylenes, copolymers of ethylene/ethyl acrylate, copolymers of ethylene/vinyl acetate and combinations thereof.

In the above composition for forming an insulating film, said polyphenylene (A) is preferably a compound formed through a Diels-Alder reaction between a compound having a diene group(s) and a compound having a dienophile group(s), and the number of diene groups included in the compound having a diene group(s), or the number of dienophile groups included in the compound having a dienophile group(s), or both of these numbers is/are preferably not less than 2.

Further, the above composition for forming an insulating film preferably has a relationship:

c/(a+b+c)≦0.15

wherein a represents the parts by mass of polyphenylene (A); b represents the parts by mass of styrene polymer (B); and c represents the parts by mass of block copolymer or graft copolymer (C), included in said composition.

The sizes of domains of styrene polymers formed within a polyphenylene layer of an insulating film comprising polyphenylene as a main component can be controlled by forming the insulating film using the composition for forming an insulating film according to the present invention.

As a result, the generation of spaces in which holes are connected one another (voids) can be prevented, and the sizes of the holes within the insulating film can be controlled in an order ranging from angstroms to nanometers in the insulating film comprising polyphenylene as a main component.

Therefore, by use of the composition for forming an insulating film of the present invention, holes with appropriate sizes can be generated without forming voids in an insulating film comprising polyphenylene as a main component, thereby producing a highly reliable insulating film having reduced dielectric constant.

### DETAILED EXPLANATION OF THE INVENTION

The present invention will be described in detail below.

### (A) Polyphenylene

Firstly, polyphenylene contained in the composition of the invention (herein after referred to as “the polyphenylene of the invention” or “polyphenylene (A)”) is described.

As used herein, “polyphenylene” refers to a polymer comprising a partial structure represented by either Formula (α) or (β).

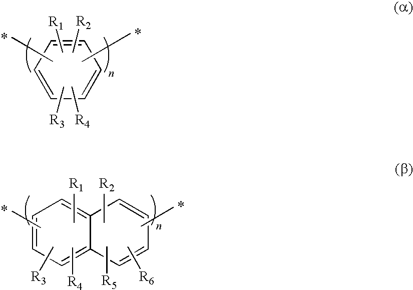

wherein n represents an integer not less than 2; and R₁-R₆ each independently represents H or an aromatic moiety either unsubstituted or having a prescribed substituent(s).

An “aromatic moiety” as used herein refers to a polyaromatic and condensed aromatic moieties such as phenyl or naphthyl group.

In case where any of aromatic moieties of R₁-R₆ has a substituent, the substituent is a group which does not easily react with a substance included in the environment, such as water, of the insulating film being formed in a microelectronic device. Examples of such substituent include F, Cl, Br, —CF₃, —OCH₃, —OCF₃, —OPh, C₁-C₈ alkyls, and C₃-C₈ cycloalkyls.

The polyphenylene used for the composition of the present invention is preferably a compound formed through a Diels-Alder reaction between a compound having at least one diene group and a compound having at least one dienophile group. Polyphenylenes formed through Diels-Alder reactions are preferable in that the resulting polymer products do not contain metal contaminants since no metal catalyst is used in the polymerization reaction, unlike polyphenylene produced by, for example, cationic polymerization using aluminum chloride-copper chloride catalysts or dehalogenation polymerization using dihalobenzen and transition metal complex catalysts. Such transition metals are not preferable because they may induce unnecessary oxidation during prebaking and the subsequent curing processes due to their high catalytic potentials to accelerate oxidation, thereby elevating the dielectric constant of the insulating film produced from the composition of the invention (the film of the invention).

Diels-Alder reaction is a reaction in which a diene group and a dienophile group react with each other to produce an adduct such as a six-membered ring. In Diels-Alder reaction, the condition may be adequately altered depending on the compounds to react and the purpose of the reaction.

Examples of a preferable solvent used in the Diels-Alder reaction applied to the synthesis of the polyphenylene contained in the composition of the invention include mesitylene, pyridine, triethylamine, N-methyl pyrrolidinone (NMP), methyl benzoate, ethyl benzoate, butyl benzoate, cyclopentanone, cyclohexanone, cycloheptanone, cyclooctanone, cyclohexylpyrrolidinone, ethers or hydroxy ethers such as dibenzyl ether, diglyme, triglyme, diethylene glycol ethyl ether, diethylene glycol methyl ether, dipropylene glycol methyl ether, dipropylene glycol dimethyl ether, propylene glycol phenyl ether, propylene glycol methyl ether, tripropylene glycol methyl ether, toluene, mesitylene, xylene, benzene, dipropylene glycol monomethyl ether acetate, dichlorobenzene, propylene carbonate, naphthalene, diphenyl ether, butyrolactone, dimethylacetamide, dimethylformamide and mixtures thereof Among these preferable solvents are mesitylene, N-methylpyrrolidinone (N), γ-butyrolactone, diphenyl ether and mixtures thereof

The duration and temperature of Diels-Alder reaction vary largely depend on the monomer used, in particular, the reactivity thereof, the desired oligomer or polymer, and solvent used. In general, a reaction for producing an oligomer is conducted at a temperature in the range of 150-250° C. for 1-48 hours.

The diene group is not limited, however, cyclopentadienone is preferred. The dienophile group is not limited, and the examples thereof include ethylene, acetylene and nitrile groups, and amongst acetylene group is preferable.

In the polyphenylene according to the invention, the number of diene groups included in said compound having a diene group(s) is preferably not less than 2, and more preferably not less than 3. In addition, the number of dienophile groups included in said compound having a dienophile group(s) is preferably not less than 2, and more preferably not less than 3.

Further, it is preferable that both the number of diene groups included in said compound having a diene group(s) and the number of dienophile groups included in said compound having a dienophile group(s) are not less than 2, and more preferably not less than 3.

The polyphenylene of the present invention is preferably an oligomer or a polymer represented by any of the Formulae (I)-(IV).

[A]_{W} [B]_{T} [E]_{V} Formula (I):

In the Formula (I), A has the following structure;

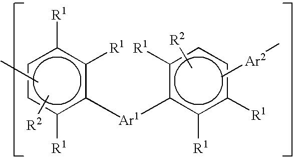

B has the following structure; and

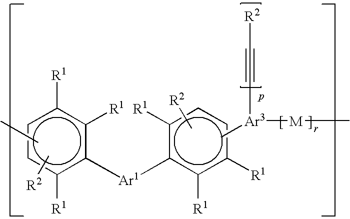

E is a terminal group having at least one of the following structures.

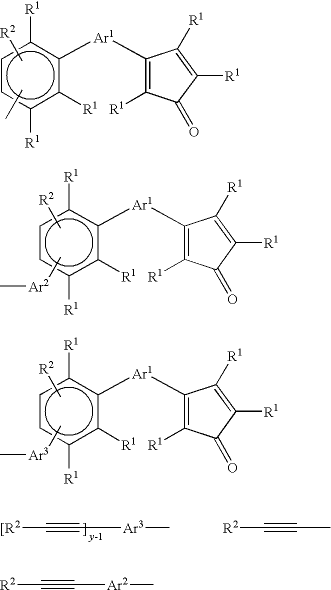

wherein M is a single bond; y is an integer not less than 3, preferably not less than 6, and more preferably between 3-5; p is the number of unreacted acetylene groups included in a monomer unit; r is a number which is smaller by 1 than the number of reacted acetylene groups included in the monomer unit; and p+r=y−1. In addition, W is an integer of 0-1,000, and preferably 10-500; T is an integer of 0-1,000, and preferably 10-500; V is an integer not less than 2; and W+T≧1.

In the Formula (I), R¹ and R² are each independently H or an unsubstituted or inertly substituted aromatic moiety. Ar¹, Ar² and Ar³ are each independently an unsubstituted or inertly substituted aromatic moiety.

As used herein an “aromatic moiety” refers to phenyl, a polyaromatic and condensed aromatic moieties, and the like.

Being “inertly substituted” means that the substituent is intrinsically inert in the polymerization reaction between cyclopentadienone and acetylene, and does not easily react with a substance included in the environment such as water under the condition where cured the polymer is used in a microelectronic device. Examples of such substituent include F, Cl, Br, —CF₃, —OCH₃, —OCF₃, —OPh, C₁-C₈ alkyls, and C₃-C₈ cycloalkyls.

Specific examples of the “inertly substituted aromatic moiety” include followings:

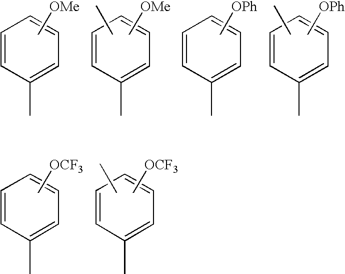

wherein Me means a methyl group.

Specific examples of the “unsubstituted aromatic moiety” include followings:

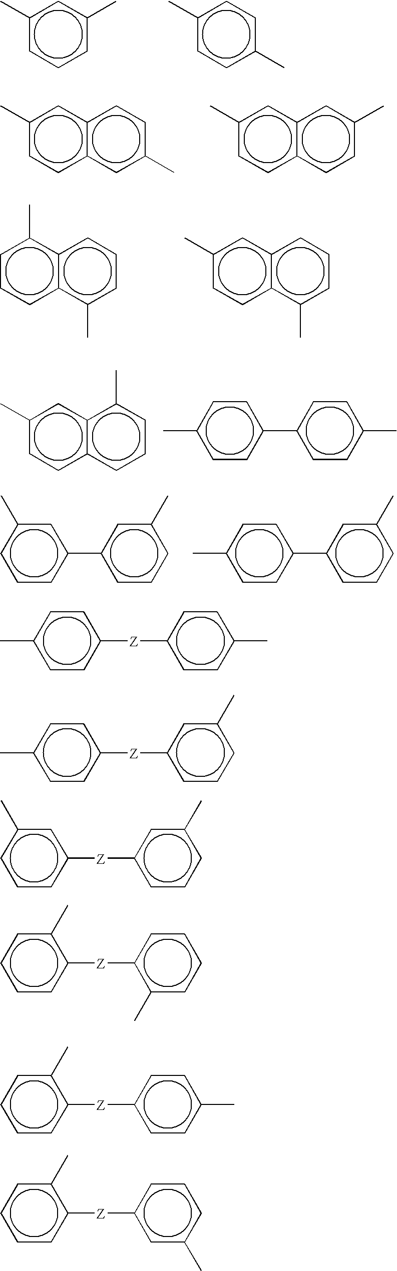

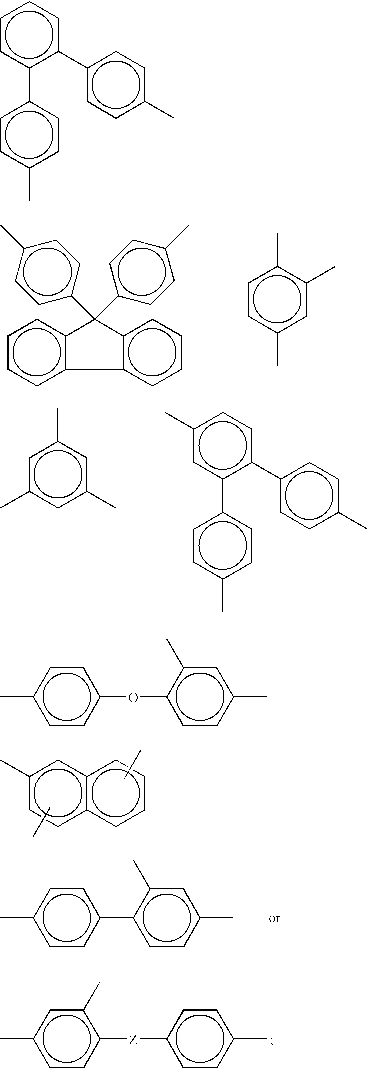

wherein Z represents a connecting group and examples thereof include —O—, —S—, alkylene, —CF₂—, —CH₂—, —O—CF₂—, perfluoroalkyl, perfluoroalkoxy and the like.

Such oligomers or polymers represented by the Formula (I) can be produced by reacting a bis(cyclopentadienone) represented by the Formula (a) and an aromatic acetylene comprising at least 3 acetylene groups represented by the Formula (b) with each other. If desired, a multifunctional compound having 2 aromatic acetylene groups represented by the Formula (c) may also be allow to react.

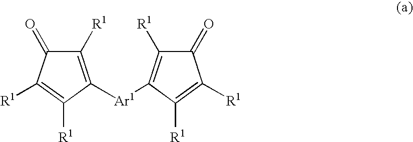

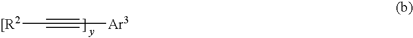

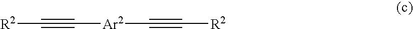

R¹, R², Ar¹, Ar², Ar³ and y in the Formulae (a)-(c) have the same meanings as those shown in the above Formula (I).

Then, oligomers or polymers represented by the Formula (II) will be described.

The polyphenylene of the present invention is preferably an oligomer or a polymer represented by the Formula (II).

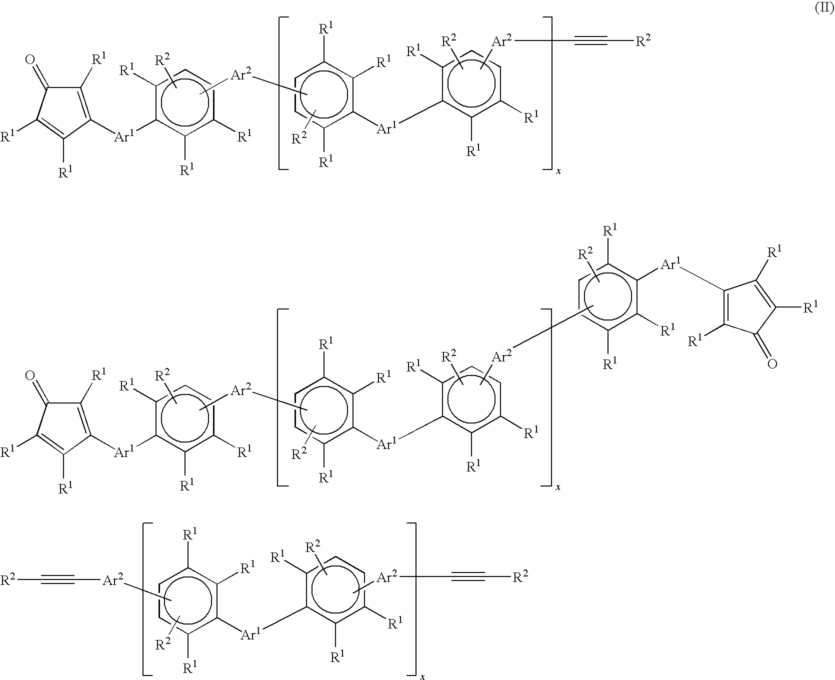

R¹, R², Ar¹ and Ar² in the Formula (II) have the same meanings as those shown in the above Formula (I). X is an integer of 1-1,000, preferably an integer of 1-50, and more preferably an integer of 1-10.

The oligomers or polymers represented by the Formula (II) can be produced through a reaction between bis(cyclopentadienone) represented by the following Formula (d) and diacetylene.

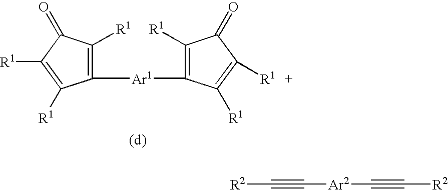

R¹, R², Ar¹ and Ar² in the Formula (d) have the same meanings as those shown in the above Formula (I).

When producing an oligomer or a polymer represented by the Formula (II) through a reaction between bis(cyclopentadienone) of the Formula (d) and diacetylene, it is preferable that the bis(cyclopentadienone):diacetylene are reacted with each other in a molar ratio of 1: 1-1:3, and still preferably 1:1-1:2.

Then, oligomers or polymers represented by the Formula (III) will be described.

The polyphenylene of the present invention is preferably an oligomer or a polymer represented by the Formula (III).

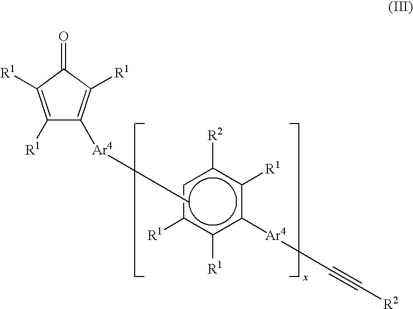

Ar⁴ in the Formula (III) is an aromatic moiety or an inertly substituted aromatic moiety as in the cases with Ar¹, Ar² and Ar³; R¹ and R² have the same meanings as those shown in the above Formula (I); and X has the same meaning as that shown in the above Formula (II).

The oligomer or polymer represented by the Formula (III) is produced through a reaction between the acetylene group and cyclopentadienone group in the multifunctional compound represented by the following Formula (e).

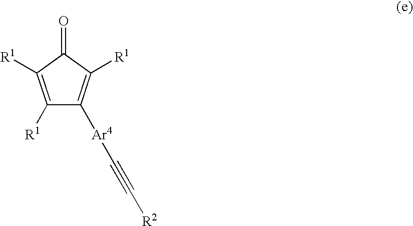

In the Formula (e), R¹ and R² have the same meanings as those shown in the above Formula (I), whereas Ar⁴ has the same meaning as that shown in the above Formula (III).

Then, oligomers or polymers represented by the Formula (IV) will be described.

The polyphenylene of the present invention is preferably an oligomer or a polymer represented by the Formula (IV).

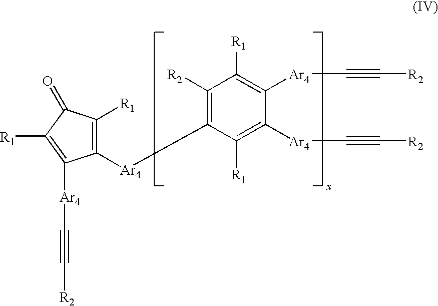

In the Formula (IV), R¹ and R² have the same meanings as those shown in the above Formula (I); Ar⁴ has the same meaning as that shown in the above Formula (III); and X has the same meaning as that shown in the above Formula (II).

The oligomer or polymer represented by the Formula (IV) is produced through a reaction between the acetylene group and cyclopentadienone group in the multifunctional compound represented by the following Formula (f).

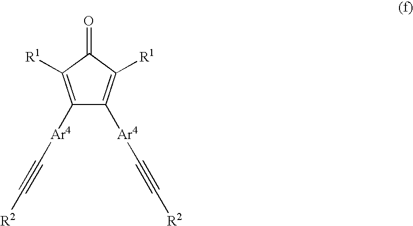

In the Formula (f), R¹ and R² have the same meanings as those shown in the above Formula (I), whereas Ar⁴ has the same meaning as that shown in the Formula (III) as described above.

The bis(cyclopentadienone) of the Formulae (a) and (d), and the compounds of the Formulae (e) and (f), which are the precursors of the polyphenylene represented by the above Formulae (I), (II), (III) and (IV), i.e., compounds having cyclopentadienone moieties can be produced through condensation reactions between benzyl and benzyl ketone using any of conventional methods. Examples of such conventional methods include those described in Kumar et al., Macromolecules, 1995, 28, 124-130, Ogliaruso et al., J. Org. Chem., 1965, 30, 3354, Ogliaruso et al., J. Org. Chem., 1963, 28, 2725 and U.S. Pat. No. 4,400,540.

The diacetylenes of the Formulae (b), (c) and (d), and the compounds of the Formulae (e) and (f), which are the precursors of the polyphenylene represented by the above Formulae (I), (II), (III) and (IV), i.e., compounds having aromatic acetylene moieties can be produced by conventional methods. That is, the compounds having aromatic acetylene moieties can be produced by halogenating an aromatic compound, and then reacting the thus halogenated aromatic compound with an appropriate substituted acetylene in the presence of an arylethynylating catalyst represented by palladium complexes.

With regard to the polyphenylene included in the composition according to the invention, reaction mechanisms generally known for reactions in which a compound having a dienophile group(s) and a compound having a diene group(s), which are the precursors, cause polymerization to produce polyphenylenes will be described below. For example, the production of the oligomer or polymer of the above Formula (II) is generally considered to be represented by the reaction formula of the Formula (g) as shown below.

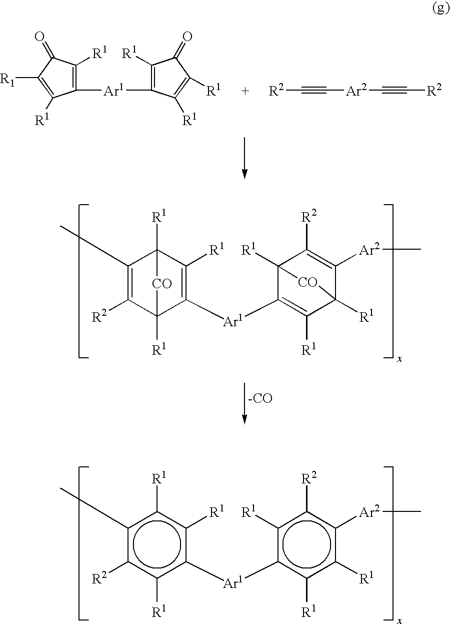

In the Formula (g), R¹ and R² have the same meanings as those shown in the above Formula (I), whereas Ar¹ and Ar² have the same meanings as those shown in the above Formula (III).

Although not shown in the Formula (g), the thus produced oligomers or polymers, which are the polyphenylenes of the invention, may contain some compounds cross-linked thereto by carbonyl bridges depending on the polyphenylene precursor (see below for the definition) and the reaction condition used. In this case, it is considered that substantially all of the carbonyl bridged substances are converted to aromatic rings by further heating. When using more than one type of acetylene-containing monomers, it is suggested from the structures thereof that block oligomers or polymers would be formed, nevertheless, the formed oligomers and polymers seem to be random ones. It is assumed that a Diels-Alder reaction occurs between a cyclopentadienon and acetylene groups to form a para- or meta-linkage on the phenylated ring.

The polyphenylene of the present invention is preferably an oligomer or a polymer represented by the Formulae (I)-(IV) as described above. The weight-average molecular weight of the polyphenylene compound of the invention is preferably from 2,000 to 500,000, more preferably from 4,000 to 250,000, still more preferably from 6,000 to 100,000, and the most preferably from 8,000 to 60,000.

The content of the polyphenylene of the invention included in the composition of the invention is preferably 40-98% by mass, more preferably 45-95% by mass, and still more preferably 50-90% by mass relative to the total solid content included in the composition of the invention.

As used herein, the total solid content included in the composition of the invention refers to the whole components except for the organic solvent(s).

### (B) Styrene Polymer (Hole Forming Agent)

Styrene polymer (B) included in the film forming composition of the present invention is a substance having a function of producing holes within a film comprising polyphenylene (A) as a main component. A film containing holes therein may be obtained by heating a film formed from a composition containing styrene polymer (B) to form holes of the styrene polymer inside the film.

Styrene polymer (B) which serves as a hole forming agent causes thermal decomposition at a temperature lower than the thermal decomposition temperature of polyphenylene (A).

Styrene polymer (B) which serves as a hole forming agent may be any of homopolymers, block copolymers, random copolymers and the like or mixtures thereof It may also be in a form of linear, branched, hyperbranched, dendritic or star-shaped.

Examples of the most preferable styrene polymer which can be used as a hole forming agent included in the composition of the invention include anionic polymerized styrene polymers, syndiotactic polystyrenes, and unsubstituted and substituted polystyrenes (e.g., poly(α-methylstyrene)s), and in particular, unsubstituted polystyrenes are preferable.

Styrene polymers are preferable because they decompose at a temperature where polyphenylene (A) does not decompose (e.g., about 420° C.-450° C.) in a matrix comprising polyphenylene (A) as a main component, and primarily decompose to the monomers thereof, which monomers then disperse out of the matrix.

Preferable molecular weight of styrene polymer (B) which serves as a hole forming agent can be adequately selected depending on a variety of factors such as the compatibility with polyphenylene (A) and the matrix produced by polymerizing and curing the polyphenylene (A) and the sizes of the holes within the insulating film. In general, the number-average molecular weight (Mn) of styrene polymer (B) which serves as a hole forming agent is preferably 2,000-100,000, more preferably, 5,000-50,000, and still more preferably, 5,000-35,000. It is preferable that the molecular weight distribution thereof (Mw/Mn=1.01-1.5) is narrow.

As for polyphenylenes and various types of styrene polymers as described above, when a styrene polymer as a hole forming agent is to be removed by heating as described below, it is preferable to select a polyphenylene and a styrene polymer so that the polyphenylene is formed before the styrene polymer vaporizes or decomposes by heating, and the styrene polymer preferably vaporizes or decomposes completely or substantially completely before the polyphenylene vaporizes or decomposes. Preferably, the temperature where the polyphenylene forms cross-linkages and the temperature where the styrene polymer as a hole forming agent vaporizes or decomposes differ largely so that the broader range of choice of styrene polymer which serves as a hole forming agent would be available.

The content of styrene polymer (B) included in the composition of the invention is preferably 10-60% by mass, more preferably 15-55% by mass, and still more preferably 20-50% by mass relative to the total solid content.

(C) Block Copolymer or Graft Copolymer of Unit having an Affinity to said Polyphenylene (A) and Unit having an Affinity to said Styrene Polymer (B)

The composition of the invention is characterized by containing a block copolymer or a graft copolymer comprising a unit having an affinity to polyphenylene (A) and a unit having an affinity to styrene polymer (B) (herein after referred to as “polymer (C)”).

As used herein, the unit having an affinity to polyphenylene (A) refers to a polymer unit or polymer segment which is dispersible and miscible in the layer composed of polyphenylene (A) at a molecular level.

Similarly, the unit having an affinity to styrene polymer (B) refers to a polymer unit or polymer segment which is dispersible and miscible in the layer composed of styrene polymer (B) at a molecular level.

In general, a mixture of different type polymers such as the case with polyphenylene and styrene polymer, these polymers rarely dissolve each other, i.e., being miscible at a molecular level. Therefore, the styrene polymer becomes phase-separated from the polyphenylene matrix and forms discrete domains (herein after referred to as “domains”) having prescribed sizes.

It is demanded that the styrene polymer forms domains in sizes of certain levels because the generation of a certain size of domain from styrene polymer within the polyphenylene matrix would facilitate formation of firm holes even after the decomposition/vaporization of the styrene polymer through a subsequent heating step or electromagnetic radiation/electron beam irradiation step.

In order to lower the dielectric constant of an insulating film containing polyphenylene as a main component to a value smaller than 2.2 by using a styrene polymer, the amount of the styrene polymer used should be increased.

However, when simply increasing the amount of the styrene polymer to be used, individual holes formed in the matrix tend to connect to one another to form larger domains. When the domain of styrene polymer formed in the polyphenylene phase becomes too large, then the hole formed therefrom would also become large in association therewith, leading to the formation of a very large space or crevice (void)

Such void largely reduces the reliability of the electronic device produced.

The present inventors have discovered that addition of polymer (C) to a composition for forming an insulating film comprising polyphenylene and styrene polymer enables to control the size of domain formed by styrene polymer in polyphenylene matrix. To a system consisting of polyphenylene-styrene polymer in which voids having sizes in the order of several ten to several hundred nanometers are formed in the absence of polymer (C), application of polymer (C) enables to control the sizes of the holes in the order of several angstroms to several nanometers

Polymer (C) seems to have a function to reduce the surface energy of phase-separated polyphenylene and styrene polymer and decrease the sizes of domains of the styrene polymer in the polyphenylene.

Therefore, polymer (C) is considered to have a similar function to that of a surfactant for a binary system consisting of water and oil.

This can be comprehended in the same manner as a phenomenon where a surfactant is added to a mixture containing water and oil which are phase-separated from each other, the surfactant intervenes to the interface between the oil molecules and the water molecules, and then the oil molecules form minute micelles to disperse into water

Although a polyphenylene chain as such can be used as a unit having an affinity to polyphenylene (A) among the units composing polymer (C), other units can also be used. Such a unit is selected from the group consisting of polyethylenes, polypropylenes, polyisobutylenes, polybutadienes, hydrogenated polybutadienes, polyisoprenes, polychloroprenes, polyvinyl chlorides, polyvinylidene chlorides, polyvinyl alcohols, polyvinyl acetates, polyvinyl propionates, poly(alkyl acrylate)s (wherein the alkyl is preferably C₁-C₁₀, and more preferably C₁-C₅), poly(alkyl methacrylate)s (wherein the alkyl is preferably C₁-C₁₀, and more preferably C₁-C₅), polyacrylonitriles, polymethacrylonitriles, polyoxymethylenes, polyethylene oxide, polypropylene oxides, polyacenaphthylenes and copolymers thereof Among these, polyethylenes, polypropylenes, polybutadienes, hydrogenated polybutadienes, polyacenaphthylenes, copolymers of ethylene-ethyl acrylate, and copolymers of ethylene-vinyl acetate are particularly preferred, and polyacenaphthylenes are the most preferable, because these compounds display excellent effects of the invention in decreasing hole sizes and inhibiting void formation.

The unit having an affinity to polyphenylene (B) which composes polymer (C) is preferably a styrene polymer chain.

Polymer (C) can be synthesized according to methods generally known as synthetic methods for block copolymers and graft copolymers.

As for polymer (C), commercial products may be used. Examples of the commercial products which may be used include MODIPER® A 1100 (graft copolymer of LDPE-PS, from NOF CORPORATION), MODIPER® A3100 (graft copolymer of PP/PS=70% by mass/30% by mass, from NOF CORPORATION), MODIPER® A4100 (grafted copolymer of EGMA/PS=70% by mass/30% by mass, wherein EGMA refers to a copolymer of ethylene/glycidyl methacrylate=85% by mass/15% by mass, from NOF CORPORATION), MODIPER® A5100 (copolymer of EEA/PS=70% by mass/30% by mass, wherein EFA refers to a copolymer of ethylene/ethyl acrylate=80% by mass/20% by mass, from NOF CORPORATION), MODIPER® A6100 (graft copolymer of EVA/PS=70% by mass/30% by mass, wherein EVA refers to a copolymer of ethylene/vinyl acetate=85% by mass/15% by mass, from NOF CORPORATION) and the like.

The number-average molecular weight of polymer (C) included in the composition of the invention is preferably from 1,000 to 500,000, and more preferably from 2,000 to 200,000, and the most preferably from 4,000 to 100,000.

The content of polymer (C) included in the composition of the invention preferably has a relationship: 0.001≦c /(a+b+c)≦0.150;
more preferably, 0.005≦c /(a+b+c)≦0.100;
still more preferably, 0.010≦c /(a+b+c)≦0.080; and
the most preferably, 0.020≦c /(a+b+c)≦0 070,
   wherein a represents the parts by mass of polyphenylene (A); b represents the parts by mass of styrene polymer (B); and c represents the parts by mass of polymer (C) being a block copolymer or graft copolymer.

The content of polymer (C) in the above ranges is preferable because when the content of polymer (C) is lower than the above described ranges, the effect of the invention exerted by addition of polymer (C) is not provided sufficiently, on the other hand, when the content of polymer (C) exceeds the above described ranges, polymer (C) as such is prone to be phase-separated from polyphenylene (A) and styrene polymer (B), leading to increases of hole sizes and formation of voids.

Then, other components in the composition of the invention will be described.

The composition of the invention contains an organic solvent(s) which dissolves the above described polyphenylene (A), styrene polymer (B) and polymer (C).

Examples of said organic solvent include 1-methoxy-2-propanol, propanol, acetylacetone, cyclohexanone, propylene glycol monomethyl ether acetate, butyl acetate, methyl lactate, ethyl lactate, γ-butyrolactone, anisole, mesitylene, and t-butylbenzene. Among these, 1-methoxy-2-propanol, cyclohexanone, propylene glycol monomethyl ether acetate, ethyl lactate, γ-butyrolactone, t-butylbenzene and anisole are particularly preferred. These compounds can be used alone or as a combination of more than one.

As described below, the polyphenylene contained in the composition of the invention can be synthesized by adding a polyphenylene precursor to an inert organic solvent and heating the resulting mixture, and said inert organic solvent of the solution produced by the synthesis is the above mentioned organic solvent. The solution produced by adding a polyphenylene precursor to an inert organic solvent and heating the resulting mixture contains the polyphenylene of the invention, wherein at least a portion of the polyphenylene of the invention is dissolved in said inert organic solvent.

The composition of the invention may be one consisting of the above described polyphenylene (A), styrene polymer (B), polymer (C) and said organic solvent, however, it may further comprise a surfactant. By containing a surfactant, it becomes easier to control the thickness of the insulating film produced from the composition of the invention in a uniform range.

Examples of said surfactant include nonionic surfactants, anionic surfactants, cationic surfactants, silicone surfactants, fluorine-containing surfactants, polyalkylene oxide surfactants and acrylic surfactants. These surfactants can be used either alone or as a combination of more than one. Among these, silicone surfactants, nonionic surfactants, fluorine-containing surfactants and acrylic surfactants may be preferably used, and silicone surfactants can be used more preferably.

As used herein, a silicone surfactant means a surfactant containing at least one Si atom. As described above, the composition of the present invention preferably contains a silicone surfactant, and among silicone surfactants, those having structures containing an alkylene oxide and dimethyl siloxane are more preferable. Still more preferably, said silicone surfactant has a structure containing the Formula (h) as shown below.

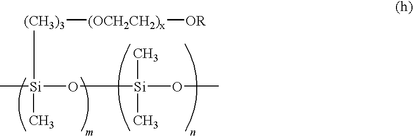

In the Formula (h), R is a hydrogen atom or a C₁-C₅ alkyl group; x is an integer of 1-20; and m and n each independently is an integer of 2-100. Multiple Rs may be the same or different.

The content of the above described surfactant is preferably 0.1-10% by mass, and more preferably 1.0-5.0% by mass relative to the total solid content included in the composition of the present invention.

In addition, the composition of the present invention may also contain additives such as radical generators, colloidal silica, silane coupling agents, adherence agents or adherence assistants. The amounts of these additives to be added are not limited as long as they do not affect the properties of the insulating film (e.g., heat resistance), however, are preferably not more than 50% by mass, and more preferably, not more than 30% by mass relative to the total solid content included in the composition of the present invention.

Representative examples of the adherence agent or adherence assistant used for the composition of the invention include silanes, preferably organosilanes such as alkoxy silanes (for example, trimethoxyvinylsilane, triethoxyvinylsilane, tetraethoxysilane, phenyltrimethoxysilane, allyltrimethoxysilane, divinyldiethoxysilane), acetoxy silanes (for example, vinylacetoxysilane, 3-aminopropyltrimethoxysilane), and hydrolysates or dehydrated condensates thereof, hexamethyldisilazane [(CH₃)₃—Si—NH—Si(CH₃)₃], or amino silane couplers such as γ-aminopropyltriethoxysilane, or chelate compounds (for example, aluminium monoethyl acetoacetate diisopropylate [((iso-C₃H₇O)₂Al(OCOC₂H₅CHCOCH₃))] and aluminum alkoxide for aluminium oxide formation). These materials may be used in the form of a mixture. Alternatively, those commercially available as adhesion promoters may be used.

In general, the amount of the adherence assistant to be added to the film forming composition is 0.05-5% by mass, and preferably 0.1-2% by mass relative to the total solid content.

The concentration of the total solid content included in the composition of the invention is preferably 0.1-50.0% by mass, more preferably 0.5-15% by mass, and still more preferably 1-10% by mass.

The composition of the present invention preferably contains metals as contaminants at a sufficiently low level.

The content of transition metals included in the composition of the invention is preferably not more than 10 ppm, more preferably not more than 1 ppm, and still more preferably not more than 100 ppb as measured by ICP-MS method. This is because transition metals are considered to have high catalytic potentials to induce oxidation, hence, increase the dielectric constant of the insulating film formed from the composition of the present invention (the insulating film of the invention) through oxidation reactions in pre-baking and curing processes.

The content of metals other than transition metals included in the composition of the invention is preferably not more than 30 ppm, more preferably not more than 3 ppm, and still more preferably not more than 300 ppb as measured by ICP-MS method.

Then the method of producing the composition of the present invention will be described.

The polyphenylene included in the composition of the present invention is produced using as materials a compound having at least one diene group and a compound having at least one dienophile group. Examples of such materials include compounds represented by the above Formulae (a)-(f) (as for the Formula (d), it refers to each of bis(cyclopentadienone) and diacetylene shown in the Formula (d)). Such materials are herein referred to as “polyphenylene precursors”.

Preferably, the polyphenylene precursor is sufficiently purified. In particular, the polyphenylene precursor is preferably prepared to contain metals and ionic substances as little as possible.

For example, when multifunctional compounds comprising aromatic acetylene groups contain residual ethynylating catalysts, the residual ethynylating catalysts can be removed from said multifunctional compounds by washing with water, contacting with an aliphatic hydrocarbon solvent, subsequently dissolving in an aromatic solvent and then filtering the resulting mixture through a pure silica gel. The residual ethynylating catalysts can be further eliminated by further performing recrystallization.

The method of synthesizing polyphenylene from the above described polyphenylene precursor is not limited, however, it is preferable to produce polyphenylene by dissolving the polyphenylene precursor in an inert organic solvent and heating the resulting mixture at an appropriate polymerization temperature under any of atmospheric, reduced and super- atmospheric pressures, because polyphenylene having a uniform molecular weight can easily be obtained and heat generated through the reactions can be relieved. In addition, since the solution containing polyphenylene obtained by the above method is already being a composition according to the present invention, operations such as addition of polyphenylene to the above described organic solvent are not necessary.

Examples of the above described inert organic solvent include mesitylene, pyridine, triethylamine, N-methyl pyrrolidinone (NMP), methyl benzoate, ethyl benzoate, butyl benzoate, cyclopentanone, cyclohexanone, cycloheptanone, cyclooctanone, cyclohexylpyrrolidinone, ethers and/or hydroxy ethers such as dibenzyl ether, diglyme, triglyme, diethylene glycol ethyl ether, diethylene glycol methyl ether, dipropylene glycol methyl ether, dipropylene glycol dimethyl ether, propylene glycol phenyl ether, propylene glycol methyl ether, tripropylene glycol methyl ether, toluene, mesitylene, xylene, benzene, dipropylene glycol monomethyl ether acetate, dichlorobenzene, propylene carbonate, naphthalene, diphenyl ether, butyrolactone, dimethylacetamide, dimethylformamide and mixtures thereof Preferable inert organic solvents amongst are mesitylene, N-methylpyrrolidinone (NMP), γ-butyrolactone, diphenyl ether and mixtures thereof.

Reaction conditions where polymerization reaction of the polyphenylene precursor occurs the most advantageously such as reaction temperature and reaction duration vary depending on various factors including the types of the polyphenylene precursor and the above described inert organic solvent.

For example, an oligomer can be formed from a polyphenylene precursor by setting the reaction temperature in the range of 100° C.-475° C. and the reaction duration in the range from 1 minute to 48 hours. The reaction temperature is preferably set in the range of 150° C.-450° C., and more preferably 200° C.-250° C. The reaction duration is preferably set in the range from 60 minutes to 48 hours, more preferably 1 minute to 10 hours, and still more preferably 1 minute to 1 hour. Further, chain extension (advancement) may be performed.

The polymerization reaction of the polyphenylene precursor may be performed under nonoxidative atmosphere such as nitrogen or other inert gases.

Then, the insulating film of the invention which can be produced from the composition of the invention will be described.

Firstly, the method for producing the insulating film of the invention will be described.

The insulating film of the invention is preferably produced in such a way that the composition of the invention is coated on a substrate by any method including spin coating, roller coating, dip coating and scan methods, and then heat-treated, after which the above mentioned organic solvent is removed.

Spin coating or scan method is preferred as a method for coating the substrate, and spin coating method is more preferable. Commercially available machines may be used for spin coating. For example, CLEAN TRACK® series (Tokyo Electron Limited), D-SPIN series (DAINIPPON SCREEN MFG. CO., LTD.), SS series or CS series (TOKYO OHKA KOGYO CO., LTD.) and the like may be preferably used.

As for the condition of spin coating, any rotation speed may be employed, however, for coating a 300 mm silicone substrate, the rotation speed is preferably around 1300 rpm because such speed would yield excellent in-plane uniformity in the thus formed insulating film of the invention.

The method for discharging the composition of the invention may be either dynamic discharge in which the composition of the invention is discharged onto a rotating substrate or static discharge in which the composition of the invention is discharged onto a stationary substrate, however, dynamic discharge is preferred in view of in-plane uniformity of the formed insulating film of the invention. Alternatively, a method in which only the organic solvent included in the composition of the invention is preliminarily discharged on to the substrate to form a liquid film and then the composition of the invention is discharged over the liquid film may be employed for the purpose of controlling the consumption of the composition of the invention. In this method, when more than one organic solvents are contained, only one having higher (or the highest) content may be used to form the liquid film. Duration of spin coating is not limited, however, it is preferably not more than 80 seconds in view of throughput. Moreover, in view of substrate transfer, it is preferable to perform an appropriate treatment (edge rinse and back rinse) so as not to allow the film to remain on the edge part of the substrate.

The method of heat treatment is not limited, and methods generally employed such as hot plate heating, a heating method using a furnace, heating by photo-irradiation using xenon lamps of RTPs (Rapid Thermal Processors) may be applied. Preferable methods are the hot plate heating and heating method using a furnace.

With regard to the hot plate, a commercially available equipment may be preferably used, and for example, CLEAN TRACK® series (Tokyo Electron Limited), D-SPIN series (DAINIPPON SCREEN MFG. CO., LTD.), SS series or CS series (TOKYO OHKA KOGYO CO., LTD.) and the like may be preferably used. As for the furnace, α series (Tokyo Electron Limited) and the like may be preferably used.

The polyphenylene contained in the composition of the invention is preferably cured by heat treatment after being coated on a base plate. The strength of the insulating film produced can be enhanced, for example, by allowing carbon-carbon triple and/or double bonds remaining in the polyphenylene contained in the composition of the invention to cause polymerization reactions. The condition of this heat treatment is as follows: preferably at 100-450° C., more preferably at 200-420° C., and still more preferably at 350-400° C.; and preferably for 1 minute to 2 hours, more preferably for 10 minutes to 1.5 hours, and still more preferably for 30 minutes to 1 hour.

The heat treatment may be performed dividedly in several times. In addition, the heat treatment is preferably performed under nitrogen atmosphere so as to prevent thermal oxidation.

Alternatively, carbon-carbon triple and/or double bonds remaining in the polyphenylene contained in the composition of the invention may be allowed to cause polymerization reaction by irradiating high energy beams thereto after coating the composition of the invention on the base plate, instead of the above described heat treatment.

Examples of the high energy beam include electron beams, ultraviolet rays, X-rays and the like, however, not limited thereto.

In case where an electron beam is used as a high energy beam, the energy level is preferably 0-50 keV, more preferably 0-30 keV, and still more preferably 0-20 keV. The total dose of the electron beam is preferably 0-5 μC/cm², more preferably 0-2 μC/cm², and still more preferably 0-1 μC/cm². In the electron beam irradiation the temperature of the substrate is preferably 0-450° C., more preferably 0-400° C., and still more preferably 0-350° C. In the electron beam irradiation the pressure of the atmosphere is preferably 0-133 kPa, more preferably 0-60 kPa, and still more preferably 0-20 kPa.

Further, in the electron beam irradiation, it is preferable to use an inert atmosphere such as Ar, He and nitrogen as the ambient atmosphere of the base plate in order to prevent oxidation of the polyphenylene contained in the composition of the invention. Moreover, gases such as oxygen, carbon dioxide and ammonia may be added for the purpose of reactions with plasma, electromagnetic waves and chemical species generated by interaction with the electron beam.

The irradiation of electron beam may be performed several times, and in this case, the condition of each irradiation does not necessarily have to be the same, and may differ every time.

Alternatively, ultraviolet rays may be used as a high energy beam. When using ultraviolet rays, the irradiation wavelength range is preferably 160-400 nm, meanwhile, the output is preferably 0.1-2000 mWcm⁻² right on the base plate. In the ultraviolet ray irradiation the temperature of the base plate is preferably 250-450° C., more preferably 250-400 ° C., and still more preferably 250-350° C. In the ultraviolet ray irradiation, it is preferable to use an inert atmosphere such as Ar, He and nitrogen as the ambient atmosphere of the base plate in order to prevent oxidation of the polyphenylene contained in the composition of the invention. Furthermore, in the ultraviolet ray irradiation the pressure is preferably 0-133 kPa.

The insulating film of the present invention can be prepared by the above described methods. The thickness of the insulating film of the invention is not limited, however, is preferably 0.01˜10 μm, more preferably 0.02˜5 μm, and still more preferably 0.031˜1 μm.

As used herein, the thickness of the insulating film of the invention means a simple average of thickness values measured at given points not less than three using an optical interferometric film thickness gauge

In case where the insulating film of the invention is used as an interlayer insulating film for semiconductors, it may have a barrier layer on the wired side for preventing metal migration, as well as a cap layer, an interlayer bonding layer, and an etching stopper layer, which prevent ablation in CMP (chemical mechanical polishing), on the upper and bottom faces of the wires and interlayer insulating film. Furthermore, the layer of the interlayer insulating film may be divided into several layers by other types of materials if needed.

As for CMP slurries (chemical solution), those commercially available (e.g., products from Fujimi Incorporated, Rodel-Nitta Corporation., JSR Corporation., and Hitachi Chemical Company, Ltd.) may be adequately used. As for CMP machines, those commercially available (e.g., products from Applied Materials and Ebara Corporation.) may be adequately used.

Washing may be performed in order to remove slurry residuals after CMP.

The insulating film of the invention may be subjected to an etching process for copper wiring and other purposes. The etching process may be either wet etching or dry etching, however, dry etching is preferred. Either of ammonia plasma or fluorocarbon plasma may be adequately used for dry etching. For such plasma, not only Ar but also gases such as oxygen, nitrogen, hydrogen and helium may be used. Further, ashing may be performed in order to remove photoresists used in processes after etching, and washing may also be performed in order to remove residuals upon the ashing.

The insulating film of the invention may be used for a variety of purposes. For example, the insulating film of the invention is suitable for insulating films used for electronic components, for example, semiconductor devices such as LSI, system LSI, DRAM, SDRAM, RDRAM and D-RDRAM, and multichip module multilayer interconnection boards. Furthermore, the insulating film of the invention may be used as an interlayer insulating film, etching stopper film, surface protective film, and buffer coat film for semiconductors, as well as a passivation film and a-ray shielding film for LSIs, a cover-lay film and overcoat film for a flexographic plate, a covercoat and liquid-crystal orientation film for flexible copper-clad substrates.

### EXAMPLES

The present invention will be described in detail by way of examples below, however, the scope of the invention is not restricted thereby.

### Synthetic Example 1

### Synthesis of polyphenylene as a Diels-Alder product from 3,3′-(oxydi-1,4-phenylene)bis(2,4,5-triphenylcyclopentadienone) (Compound (a)) and 1,3,5-triphenyl ethynylbenzene (Compound (b))

In 50 ml of γ-butyrolactone, 3,3′-(oxydi-1,4-phenylene)bis(2,4,5-triphenylcyclopentadienone) (compound (a), 7.83 g, 0.010 mol) and 1,3,5-triphenyl ethynylbenzene (compound (b), 5.68 g, (0.015 mol)) were dissolved, and the resulting solution was poured into a flask. The atmosphere inside the flask was replaced by nitrogen and the solution was heated to 200° C. with stirring. After heating for 12 hours, the solution was cooled to room temperature and then added to 50 ml of ethanol. Upon addition, polyphenylene (A-1) which is the product of the Diels-Alder reaction between compounds (a) and (b) was obtained as a precipitated powder solid. The thus obtained polyphenylene (A-1) had a weight-average molecular weight of 16,100 as measured by gel permeation chromatography (GPC) based on standard polystyrene.

### Synthetic Example 2

### Synthesis of polystyrene-acenaphthylene block copolymer by living anionic polymerization

Into a glass-made polymerization reactor which had been preliminarily cleaned with refluxed toluene and dried under vacuum, 700 mL of cyclohexane (dried over activated alumina) was poured. While maintaining the reactor at 30° C., 34.43 g of styrene (approximately 0.330 mol) which had been preliminarily purified by distillation over calcium hydride was added thereto. A sec-butyllithium solution in heptanes was added to the resulting mixture so as to amount to 3.456 mmol in terms of sec-butyllithium to initiate anionic polymerization of styrene. The resulting reaction solution was stirred for 1 hour, and then 50.31 g of a commercially available acenaphthylene (approximately 0.330 mol) sufficiently purified and dried was added thereto to initiate polymer extension reaction of polyacenaphthylene consecutively following to the production of polystyrene as described above. The above reaction solution was further stirred for 1 hour after addition of acenaphthylene, and then added to 1 L of methanol to obtain the desired block copolymer (C-1).

Block polymers of polystyrene and other polymer units (C-1)-(C-6) were obtained by the same method as the present synthetic example except that acenaphthylene to be added and consecutively polymerized following to polystyrene polymerization was replaced with other monomer species (see the column “Comonomer” shown in Table 1), and the amounts of the monomers to be added were altered.

The monomer units (“Comonomer”) which were copolymerized with polystyrene in the block copolymer syntheses and the added amounts thereof as well as the number-average molecular weights (Mn, based on standard polystyrene) of the obtained polymers as measured by gel permeation chromatography (GPC) are summarized in Table 1.

TABLE 1

| | Comonomer | | |
|---|---|---|---|
| Block | | Added | Number-Average |
| copolymer | | Amount | Molecular Weight As |
| No. | Type | (mol) | Measured By GPC (Mn) |
| (C-1) | Acenaphthylene | 0.330 | 29,500 |
| (C-2) | Acenaphthylene | 0.100 | 18,000 |
| (C-3) | Ethylene | 0.500 | 16,400 |
| (C-4) | Butadiene | 0.500 | 22,000 |
| (C-5) | Isoprene | 0.500 | 24,000 |
| (C-6) | Methyl Methacrylate | 0.330 | 26,700 |

### Synthetic Example 3

### Synthesis of terminal acrylic acid ester/polystyrene (compound (C)) used as a macromonomer for graft polymerization

Into a glass-made polymerization reactor which had been preliminarily cleaned with refluxed toluene and dried under vacuum, 700 mL of cyclohexane (dehydrated with activated alumina) was poured. While maintaining the reactor at 55° C., 50.31 g of styrene (approximately 0.330 mol) which had been preliminarily purified by distillation over calcium hydride was added thereto. A sec-butyllithium solution in heptanes was added to the resulting mixture so as to amount to 3.456 mmol in terms of sec-butyllithium to initiate anionic polymerization of styrene. The resulting reaction solution was stirred for 1 hour, and then 0.6 g of ethylene oxide which had been dried over calcium hydride was added thereto. Thirty minutes later, 0.31 g of acrylic acid chloride (3.456 mmol) dissolved in 10 mL of tetrahydrofuran which had been preliminarily dried over activated alumina was added to the resulting mixture. After another 30 minutes, the solution was cooled to room temperature, and then added to 1 L of methanol to obtain the desired terminal acrylic acid/polystyrene (compound (C)). The thus obtained compound (C) had a weight-average molecular weight (Mw) of 13,200 and a number-average molecular weight (Mn) of 12,500 as measured by gel permeation chromatography (GPC) based on standard polystyrene.

### Synthetic Example 4

### Synthesis of a graft copolymer by radical copolymerization of terminal acrylic acid/polystyrene (compound (C)) and methyl methacrylate

In a 100 mL three-necked round-bottomed flask, 0.10 g of methyl methacrylate (1 mmol) and 12.5 g of terminal acrylic acid/polystyrene (compound (C)) (1 mmol) synthesized in the above Synthetic Example 3 were dissolved in toluene. A commercially available azobisisobutyronitrile which is an initiator of radical polymerization was added to the above solution, and the resulting mixture was heated at 80° C. with stirring.

Upon completion of polymerization, the reaction solution was added to methanol to obtain the desired graft polymer (C-7) as a white precipitate.

Each polystyrene graft polymer (C-7)-(C-10) were obtained by the same method as the present synthetic example except that methacrylic acid ester to be copolymerized was replaced with other monomer species (see “Comonomer” shown in Table 2), and the incorporation ratio of each monomer in copolymerization was altered.

The monomer units (“Comonomer”) which were copolymerized with compound (C) in the graft copolymer syntheses, the incorporation ratios of compound (C) and each comonomer in copolymerization, and the number-average molecular weights (Mn, based on standard polystyrene) of the obtained polymers as measured by gel permeation chromatography (GPC) are summarized in Table 2.

TABLE 2

| | | | | Number- |
|---|---|---|---|---|
| | | | | Average |
| | Incorporated | Comonomer | | Molecular |
| Block | Amount of | | Added | Weight As |
| copolymer | Compound | | Amount | Measured By |
| No. | (C) (mol) | Type | (mol) | GPC (Mn) |
| (C-7) | 0.0010 | Methyl Methacrylate | 0.001 | 13,000 |
| (C-8) | 0.0010 | Acenaphthylene | 0.001 | 13,500 |
| (C-9) | 0.0005 | Ethyl Acrylate | 0.002 | 16,000 |
| (C-10) | 0.0005 | Acrylonitrile | 0.002 | 8,900 |

### Synthetic Example 5

### Synthesis of graft copolymer (C-I1) of polyphenylene and polystyrene

Into a glass-made reactor were added 22.69 g of 4,4′-bis(2,4,5-triphenyl ethynyl cyclopentadienone)diphenyl ether (0.0193 mol), 4.87 g of 1,3,5-Tris(phenylethynyl)benzene (0.0129 mol), 4.63 g of the polystyrene ester of 3,5-bis(phenyl ethynyl)benzoic acid (Mn 37,000) (0.000125 mol) synthesized by the same method as described in an example of Japanese Laid-open PCT Application (Kohyo) No. 2002-530505, and 50 g of γ-butyrolactone.

The atmosphere inside the flask was sufficiently replaced by nitrogen and then the above mixture was heated to 200° C. with stirring in the reactor. Forty eight hours later, the reaction solution was cooled to room temperature and then added to 500 cc of methanol to obtain the desired graft copolymer (C-11) of polyphenylene and polystyrene as a deep reddish purple colored powder. The thus obtained graft copolymer (C-11) had a number-average molecular weight of 4800 as analyzed by GPC (based on standard polystyrene).

### Examples 1-31, Comparative Example

### Preparation of a Composition for Forming an Insulating Film

A composition for forming an insulating film was prepared by completely dissolving in a solvent a solid content consisting of: 1.0 g of polyphenylene (A-1); an anionic polymerized polystyrene (the number average molecular weight: 13,200, a product from Aldrich; the added amount relative to the total solid content is summarized in Table 3 ) as a styrene polymer (a hole forming agent); polymer (C) (the type of polymer (C) used and the added amount of polymer (C) relative to the total mass of polyphenylene, polystyrene polymer and polymer (C) (c/(a+b+c)) are summarized in Table 3); and vinyl triacetoxysilane oligomers as an adherence assistant in an amount of 3.0% by mass relative to the total solid content.

### Measurement of Film Dielectric Constant

A coating solution prepared in accordance with the above procedure was spin-coated on an 8-inch bare silicone wafer having a substrate resistance of 7 Ω/cm. The thus coated film was baked at 110° C. for 60 seconds and subsequently at 200° C. for 60 seconds, and then burned in a clean oven, inside of which the atmosphere had been replaced by nitrogen, at 450 ° C. for 1 hour to obtain a coated film having a film thickness of 100 nm. The relative dielectric constant of the thus obtained film was calculated from the electric capacity value at 1 MHz using a mercury prober from Four Dimensions, Inc. and HP4285A LCR meter from Yokogawa-Hewlett-Packard Incorporation. The results are summarized in Table 3

### Confirmation of Void Size in Film

The 8-inch wafer with burned film obtained by the same method as described in “Measurement of film dielectric constant” was broken into pieces. Thin silver films were deposited on exposed sidewalls of the burned film, and the shapes of the film sidewalls were observed using a scanning electron microscope S-4800 from Hitachi High-Technologies Corporation to confirm holes existing in the film or the existence of spaces (voids). “×” represents that a void having a width not less than 30 nm was detected in the film; “Δ” represents that a void having a width less than 30 nm was detected in the film; and “∘” represents that there was no void having a size confirmable with the resolution of the electron microscope. The results are summarized in Table 3.

### Measurement of the Size of the Most Frequent Holes

The nitrogen absorption isotherms for the burned films obtained by the same method as described in “Measurement of film dielectric constants” at liquid nitrogen temperature were measured using Autosorb from Quantachrome Instruments. The thus obtained nitrogen absorption isotherms were analyzed by NLDFT Monte-Calro method (adsorbate: nitrogen, adsorbent: carbon, slit pore model) to obtain the distribution of holes existing in the obtained burned films. The hole size having the largest volume in the hole distribution was defined as the most frequent hole size. The results are summarized in Table 3.

TABLE 3

| | | | | | | | | The |
|---|---|---|---|---|---|---|---|---|
| | | Styrene | | | | | | Most |
| | | Polymer (B) | Polymer (C) | | | | | Frequent |
| | | Added | | Added | | Film | | Hole |
| | | Amount | Material | Amount | | Dielectric | Existence | Size |
| | | (wt %) | Species | (c/a + b + c) | Solvent | Constant | of Voids | (nm) |
| Example | 1 | 40 | (C-1) | 0.008 | (D-1) | 2.19 | Δ | 4.8 |
| Numbers | 2 | 40 | (C-1) | 0.05 | (D-1) | 2.15 | ∘ | 1.8 |
| | 3 | 40 | (C-1) | 0.10 | (D-1) | 2.10 | ∘ | 1.2 |
| | 4 | 50 | (C-1) | 0.10 | (D-1) | 2.00 | ∘ | 1.5 |
| | 5 | 40 | (C-2) | 0.05 | (D-1) | 2.18 | ∘ | 1.5 |
| | 6 | 50 | (C-2) | 0.05 | (D-1) | 2.05 | ∘ | 2.1 |
| | 7 | 50 | (C-2) | 0.10 | (D-1) | 2.00 | ∘ | 1.5 |
| | 8 | 40 | (C-3) | 0.05 | (D-1) | 2.17 | ∘ | 1.8 |
| | 9 | 40 | (C-3) | 0.025 | (D-1):(D-3) = 9:1 | 2.20 | ∘ | 2.1 |
| | 10 | 50 | (C-3) | 0.075 | (D-1):(D-3) = 9:1 | 2.03 | ∘ | 2.8 |
| | 11 | 40 | (C-3) | 0.05 | (D-1):(D-3) = 9:1 | 2.20 | ∘ | 2.0 |
| | 12 | 50 | (C-4) | 0.10 | (D-1) | 2.00 | ∘ | 1.9 |
| | 13 | 40 | (C-5) | 0.05 | (D-1) | 2.17 | ∘ | 3.7 |
| | 14 | 40 | (C-6) | 0.05 | (D-1) | 2.23 | Δ | 4.5 |
| | 15 | 40 | (C-7) | 0.05 | (D-1) | 2.22 | Δ | 4.3 |
| | 16 | 40 | (C-8) | 0.05 | (D-1) | 2.18 | ∘ | 1.8 |
| | 17 | 40 | (C-9) | 0.05 | (D-1) | 2.21 | ∘ | 4.6 |
| | 18 | 40 | (C-10) | 0.05 | (D-1):(D-3) = 8:1 | 2.23 | Δ | 5.0 |
| | 19 | 40 | (C-11) | 0.05 | (D-1):(D-3) = 8:1 | 2.25 | Δ | 5.0 |
| | 20 | 40 | (C-12) | 0.05 | (D-1) | 2.20 | ∘ | 1.8 |
| | 21 | 40 | (C-12) | 0.15 | (D-1) | 2.05 | ∘ | 2.5 |
| | 22 | 40 | (C-12) | 0.25 | (D-1) | 1.90 | Δ | 12.0 |
| | 23 | 40 | (C-13) | 0.05 | (D-1) | 2.20 | ∘ | 1.9 |
| | 24 | 40 | (C-13) | 0.05 | (D-1) | 2.21 | ∘ | 1.9 |
| | 25 | 40 | (C-13) | 0.05 | (D-1):(D-3) = 8:1 | 2.22 | ∘ | 1.9 |
| | 26 | 40 | (C-14) | 0.05 | (D-1) | 2.20 | ∘ | 2.0 |
| | 27 | 40 | (C-14) | 0.025 | (D-1) | 2.22 | ∘ | 1.9 |
| | 28 | 50 | (C-14) | 0.025 | (D-1) | 2.10 | ∘ | 1.8 |
| | 29 | 30 | (C-15) | 0.05 | (D-1) | 2.35 | ∘ | 0.6 |
| | 30 | 40 | (C-15) | 0.05 | (D-1) | 2.18 | ∘ | 1.5 |
| | 31 | 50 | (C-15) | 0.05 | (D-1) | 2.01 | ∘ | 2.8 |

| | | | | | | | |
|---|---|---|---|---|---|---|---|
| Comparative | 40 | — | — | (D-1) | 2.20 | x | 22.0 |
| Example | | | | | | | |

The abbreviations of material species listed in Table 3 means as follows:
(C-1)-(C-11): the compounds described in the above synthetic examples 1-5;
(C-12): MODIPER® A100 (graft copolymer of LDPE/PS=70% by mass/30% by mass, from NOF CORPORATION) (LDPE: low-density polyethylene);
(C-13): MODIPER® A3100 (graft copolymer of PP/PS=70% by mass/30% by mass, from NOF CORPORATION) (PP: polypropylene);
(C-14): MODIPER® A5 100 (copolymer of EEA/PS=70% by mass/30% by mass, from NOF CORPORATION) (EEA: ethylene/ethyl acrylate);
(C-15): MODIPER® A6100 (graft copolymer of EVA/PS=70% by mass/30% by mass, from NOF CORPORATION) (EVA: ethylene/vinyl acetate);
(D-1): cyclohexanone
(D-2): 2-heptanone
(D-3): γ-butyrolactone

As shown in Table 3, the insulating film obtained from the composition of the invention has holes with smaller sizes and little void formation while maintaining a low dielectric constant.

1. A composition for forming an insulating film, characterized by comprising:
(A) a polyphenylene,
(B) a styrene polymer, and
(C) a block copolymer or a graft copolymer, comprising a unit having an affinity to said polyphenylene (A) and a unit having an affinity to said styrene polymer (B).

2. The composition for forming an insulating film according to claim 1, characterized in that said unit having an affinity to said styrene polymer (B) is a styrene polymer chain.

3. The composition for forming an insulating film according to claim 2, wherein said unit having an affinity to said polyphenylene (A) is a polymer chain selected from the group consisting of polyethylenes, polypropylenes, polybutadienes, hydrogenated polybutadienes, polyacenaphthylenes, copolymers of ethylene/ethyl acrylate, copolymers of ethylene/vinyl acetate and combinations thereof.

4. The composition for forming an insulating film according to claim 1, characterized in that said polyphenylene (A) is a compound formed through a Diels-Alder reaction between a compound having a diene group(s) and a compound having a dienophile group(s).

5. The composition for forming an insulating film according to claim 4, wherein the number of diene groups included in said compound having a diene group(s), or the number of dienophile groups included in said compound having a dienophile group(s), or both of said numbers is/are not less than 2.

6. The composition for forming an insulating film according to any one of claim 1, having a relationship:
c/(a+b+c)≦0.15
wherein a represents the parts by mass of said polyphenylene (A); b represents the parts by mass of said styrene polymer (B); and c represents the parts by mass of said block copolymer or graft copolymer (C), in said composition.
